(19) United States
(12) Patent Application Publication
(10) Pub. No.: US 2006/0217951 A1
(43) Pub. Date: Sep. 28, 2006

(54) Apparatus that enables a simulation model of a host to interact with a simulation model of a disk drive

(76) Inventors: William Francis Heybruck, Charlotte, NC (US); Christopher Evan Ackles, Folsom, CA (US)

Correspondence Address: WAGNER, MURABITO & HAO LLP, Third Floor, Two North Market Street, San Jose, CA, 95113, US

(21) Appl. No.: 11/086,064

(22) Filed: Mar. 22, 2005

(51) Int. Cl. G06F 13/10

(52) U.S. Cl. 703/21

(57) ABSTRACT

Embodiments of the present invention pertain to an apparatus that enables a simulation model of a host to interact with a simulation model of a disk drive. In one embodiment, an instruction receiver receives instructions for the simulation model of the disk drive. The instructions are coded with a simulation language and the instructions comply with a specification that describes logic of the disk drive. The simulation model of the disk drive enables the simulation model of the host to interact with the simulation model of the disk drive. A schematic of the disk drive is not required for the purpose of enabling the simulation model of the host to interact with the simulation model of the disk drive.

### TECHNICAL FIELD

Embodiments of the present invention relate to disk drives. More specifically, embodiments of the present invention relate to simulating disk drives in a manner that does not require a schematic of the disk drive.

### BACKGROUND ART

Disk drives are typically used to store data that a host can access. The host can communicate with the disk drive, for example, by transmitting commands to the disk drive and the disk drive provides responses to those commands. Examples of commands include, but are not limited to, a request for the disk drive to perform a power on reset (referred to commonly as “power on reset”) or to provide the host with the identity of the disk drive (referred to commonly as “identify”). Additionally, the host can request to write data on the disk drive and to read the data that has been previously written to the disk drive. Examples of hosts include, but are not limited to, personal digital assistants (PDAs), digital cameras, embedded systems, computers, and MPEG Audio Layer 3 (MP3) players. Examples of disk drives include, but are not limited to, hard disk drives, micro drives, and tape drives.

Since manufacturing electronic devices, such as hosts, is expensive, frequently, the designers of a host want to test the functionality of their host using real time simulation before the host is manufactured. A system simulator can be used for testing the functionality of the host using real time simulation prior to manufacturing the host. Typically, the schematics of the host and the disk drive can be inputted to a system simulator so that the system simulator has information to determine how to simulate the functionality of the host and the disk drive. A schematic is a diagram of a logic gate design.

However, in order to protect their intellectual property, many companies do not want to provide schematics of their disk drives. This makes it difficult for other companies to test the functionality of their hosts. For example, company A that is developing a host may need to simulate the functionality of its host. In order to do this, company A would need the schematic of the disk drive that its host interacts with. However, company B which owns the disk drive does not provide schematics of its disk drives.

As a result, testing the functionality of a host is labor intensive. For example, FIG. 1 is a block diagram of a conventional computer system that is used for testing the functionality of a host when a schematic of a hard disk drive is not available. The conventional computer system 100 includes a system simulator 110 and a schematic of a host 120 with drive interface 130. The drive interface 130 is used to simulate an open connector for a host. Since a schematic of the disk drive is not available, human analysis of the outputs (which includes the timing of the outputs) from simulating the host is required, which is a labor intensive process that is prone to error.

For these and other reasons, there is a need for simulating hard disk drives that does not require a schematic of the disk drive. For these and other reasons, there is also a need for simulating disk drives that does not require human analysis of the outputs generated from simulating the host.

### DISCLOSURE OF THE INVENTION

Embodiments of the present invention pertain to an apparatus that enables a simulation model of a host to interact with a simulation model of a disk drive. In one embodiment, an instruction receiver receives instructions for the simulation model of the disk drive. The instructions are coded with a simulation language and the instructions comply with a specification that describes logic of the disk drive. The simulation model of the disk drive enables the simulation model of the host to interact with the simulation model of the disk drive. A schematic of the disk drive is not required for the purpose of enabling the simulation model of the host to interact with the simulation model of the disk drive.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of a conventional computer system that is used for testing the functionality of a host when a schematic of a hard disk drive is not available.

FIG. 2 depicts a block diagram of a computer system that enables a simulation model of a host to interact with a simulation model of a hard disk drive.

FIG. 3 depicts a flowchart 300 for a method of creating a simulation model of a disk drive, according to embodiments of the present invention.

The drawings referred to in this description should not be understood as being drawn to scale except if specifically noted.

### PREFERRED EMBODIEMENT OF THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

### Overview

In order to protect their intellectual property, many companies that own_{[ceal]} hard disk drives do not want to provide schematics of their hard disk drives to the public. However, other types of information describing the functionality of a hard disk drive are frequently provided to the public. For example, specifications that describe the functionality of disk drives are frequently provided to the public.

According to embodiments of the present invention, a simulation language is used to code instructions for a simulation model of the disk drive where the instructions comply with a specification of the hard disk drive. A system simulator is capable of using the simulation language, for example, by compiling the simulation language, interpreting the simulation language, or executing the simulation language, among other things. Thus, the simulation model of the host is enabled to interact with the simulation model of the hard disk drive without requiring a schematic of the hard disk drive, as will be described in more detail.

For example, company A that is developing a host can use the published specification, which is provided by company B that owns a hard disk drive, to code instructions for the simulation model of the hard disk drive in a simulation language. Thus, among other things, eliminating the need for a schematic of the hard disk drive and human analysis of the outputs generated by the host.

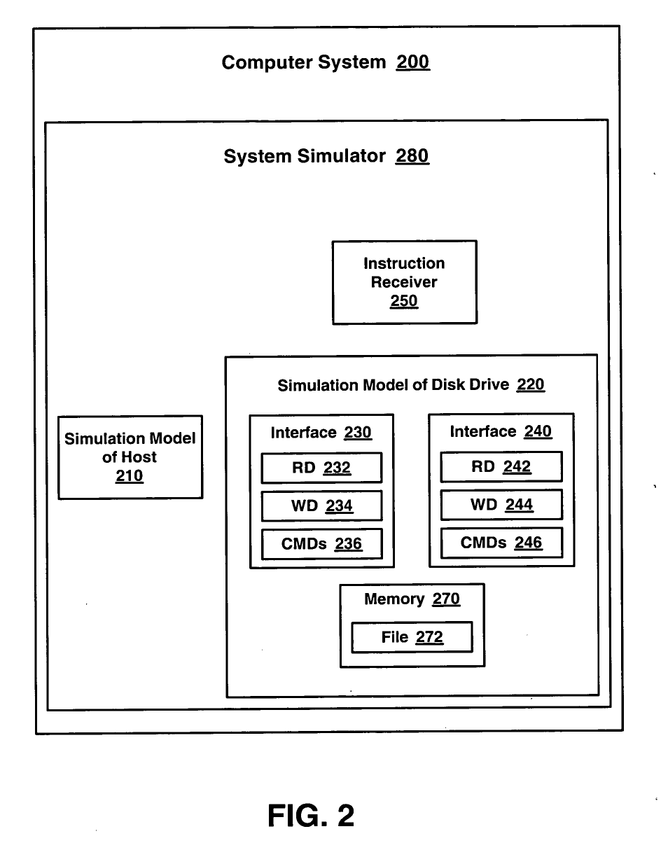

FIG. 2 depicts a block diagram of a computer system that enables a simulation model of a host to interact with a simulation model of a hard disk drive, according to embodiments of the present invention. The blocks in FIG. 2 can be arranged differently than as illustrated, and can implement additional or fewer features than what are described herein. Further, the features represented by the blocks in FIG. 2 can be combined in various ways.

A computer system 200 can be configured to execute a system simulator 280 that is capable of simulating a host and a hard disk drive using simulation models 210, 220. For example, the computer system 200 includes a system simulator 280, and a simulation model of a host 210. Further, the simulation system 280 includes an instruction receiver 250. The simulation models 210, 220 can be coded in instructions using a simulation language that the system simulator 280 is capable of simulating. Further, the Disk Drive simulation model 220 includes memory 270, which in turn includes a file 272. According to one embodiment, the file 272 is a preloaded file.

### Simulation Model of the Hard Disk Drive

The simulation model of the hard disk drive 220 is written in a simulation language that the system simulator 280 is capable of simulating, thus, the simulation model of a host 210 can interact with a simulation model of a hard disk drive 220 without requiring a schematic of the hard disk drive, according to an embodiment. Verilog™ is an example of a language that Cadence™ is capable of compiling. The simulation model of the host 210 can also be written in a simulation language, such as Verilog™, that the system simulator 280 is capable of compiling.

The simulation model of the hard disk drive 220 is coded with instructions to enable the simulation of various functions (e.g., interfaces 230, 240, read data 232, 242, write data 234, 244, commands 236, 246) that are used for communicating between the simulation models 210, 220, according to an embodiment. Thus, the simulation model of the hard disk drive 220 eliminates the need for a human to analyze the outputs generated by the simulation model of the host 210.

### A Specification that Describes the Functionality of a Disk Drive

A published specification that describes the functionality of the hard disk drive can be used for the purpose of coding the instructions of the simulation model of the hard disk drive 220, according to an embodiment. For example, the specification may contain flowcharts that describe the logic of the hard disk drive. Frequently, simulation languages include many third generation language features, such as If-Then-Else statements that can be used for coding the simulation model of the hard disk drive 220. The If-Then-Else capabilities of the simulation language can be used to code the simulation model of the hard disk drive 220 with the logic described by the flowcharts. Thus, the instructions that the simulation model of the hard disk drive 220 is coded in a manner that complies with a specification that describes the logic of the hard disk drive, which eliminates the need for a schematic of the hard disk drive

Examples of published specifications are “AT attachment-6 with Packet Interface (ATA/ATAPI-6),” published 2002 by INCITS, T13 Technical Committee and “CF+ and CompactFlash Specification Revision 3.0,” published 2004 by the CompactFlash Association.

### Interfaces

There are different types of hard disk drives and interfaces 230, 240 are used for communicating with those different types of hard disk drives. Examples of types of hard disk drives and their associated interfaces 230, 240 include, but are not limited to, compact flash and parallel ATA. The specification of a hard disk drive describes the interface 230, 240 for that type of hard disk drive. The simulation model of the hard disk drive 220 is coded with instructions to implement the interfaces 230, 240 that enable the simulation model of the host 210 to communicate with various interfaces 230, 240 for various types of hard disk drives, according to an embodiment. For example, two types of hard disk drives are compact flash and parallel ATA. Interface 230 could be used to simulate compact flash and interface 240 could be used to simulate parallel ATA. Further, for compact flash, the interfaces 230, 240 can be implemented to simulate modes associated with the hard disk drives. For example, an interface that simulates compact flash can be implemented for memory, an input/output device, or integrated device electronics (IDE) mode.

### Read Data Functionality and Write Data Functionality

According to one embodiment, from the perspective of the simulation model of the host 210, the reading and writing of data will appear to be performed by a real hard disk drive. For example, it will appear to the simulation model of the host 210 as if it were writing valid data to a real hard disk drive and reading valid data from a real hard disk drive. Further, the timing at which operations are performed will also appear to be performed by a real disk drive, for example.

The read data functionality 232, 242 and the write data functionality 234, 244 enable the simulation model of a host 210 to write data to memory 270 and to read data from memory 270, according to an embodiment. The specifications describe the read data functionality 232, 242 and the write data functionality 234, 244. The simulation model of the hard disk drive 220 is coded with instructions to implement the read data functionality 232, 242 and the write data functionality 234, 244, thus, enabling the simulation model of the host 210 to communicate with the read data functionality 232, 242 and the write data functionality 234, 244, according to an embodiment.

The file 272 can be used for writing data to and reading data from memory 270. Typically, simulations of reading and writing data require a tremendous amount of memory 270. For example, if the simulation of reading and writing 60 gigabytes of data is desired, the computer system 200 will need 60 gigabytes of real memory 270 in order to simulate the reading and writing of the 60 gigabytes of data. The file 272, according to one embodiment, is a relatively small file. For example, the file 272 may be large enough to store 2000 sectors of data. According to another embodiment, from the perspective of the simulation model of the host 210, the reading and writing of data will appear to be performed in a manner that it would have been performed by a real hard disk drive as long as the size of the file 272 is not exceeded. For example, it will appear to the simulation model of the host 210 as if it were writing and reading valid data to a real hard disk drive. Reading data beyond the size of file 272 can result in fixed data being returned (example A5A5 in hex) so that the host simulation can proceed. Reading from a sector beyond the range of the disk drive results in an error status exactly as specified and occurs in real world.

According to another embodiment, the file 272 is customized ahead of time to include a predefined set of data. When the data is read from the file 272, the data is analyzed for accuracy, according to another embodiment.

### Commands

According to one embodiment, from the perspective of the simulation model of the host 210, commands will appear to be performed by a real hard disk drive. For example, the command functionality 236, 246 enables the simulation model of a host 210 to issue commands as if interacting with a real hard disk drive and to receive valid responses to the commands, according to an embodiment. The command functionality 236, 246 can enable responses to commands that require unique responses. Examples of commands include, but are not limited to, “power on reset,” and “identify.” The specifications describe the command functionality 236, 246. The simulation model of the hard disk drive 220 is coded with instructions to implement the command functionality that enables the simulation model of the host 210 to issue commands to the simulation model of the hard disk drive 220, according to an embodiment.

### System Simulator

The system simulator 280 can be any type of system that is capable of simulating the functionality of a host and a hard disk drive, according to an embodiment. A system simulator 280 is used to enable the instructions of the simulation model of the disk drive 220 by using a simulation language that the system simulator 280 is capable of simulating to code the instructions for the simulation model of the disk drive 200, according to one embodiment. For example, a system simulator is capable of using the simulation language that the simulation model of the disk drive 220 is written in by compiling the simulation language, interpreting the simulation language, or executing the simulation language, among other things. Cadence™ is an example of a system simulator 280.

System simulators 280 enable entities, such as the two simulation models 210, 220 to interact at the binary level. Since the simulation model of the disk drive 220 enables communication with commands as well as the reading and writing of data, the simulation model of the host 210 can interact with the simulation model of the hard disk drive 220 at a higher level then what conventional system simulators 100 allow, thus, among other things, eliminating the need for human analysis of the outputs generated by the simulation model of the host 210 and making it easier to program the simulation model of the host 210, according to an embodiment.

### An Apparatus that Enables a Simulation Model of a Host to Interact with a Simulation Model of a Disk Drive

According to one embodiment, an apparatus that enables a simulation model of a host 210 to interact with a simulation model of a disk drive 220 includes an instruction receiver 250 and a simulation model of a disk drive 220. According to another embodiment, the apparatus further includes memory 270, which in turn can include a file 272. According to yet another embodiment, the apparatus includes a system simulator 280. According to still another embodiment, the apparatus includes a system simulator 280.

### Method of Creating a Simulation Model of a Disk Drive

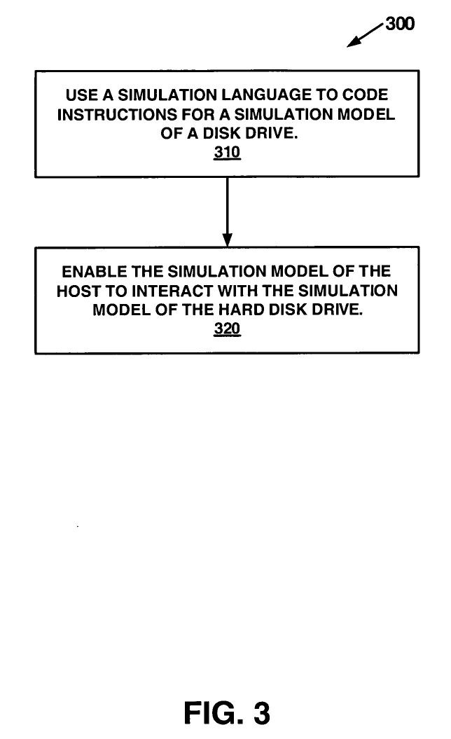

FIG. 3 depicts a flowchart 300 for a method of creating a simulation model of a disk drive, according to embodiments of the present invention. Although specific steps are disclosed in flowchart 300, such steps are exemplary. That is, embodiments of the present invention are well suited to performing various other steps or variations of the steps recited in flowchart 300. It is appreciated that the steps in flowchart 300 may be performed in an order different than presented, and that not all of the steps in flowchart 300 may be performed. All of, or a portion of, the embodiments described by flowchart 300 can be implemented using computer-readable and computer-executable instructions which reside, for example, in computer-usable media of a computer system 200 or like device.

As described above, certain processes and steps of the present invention are realized, in one embodiment, as a series of instructions (e.g., software program) that reside within computer readable memory of a computer system 200 and are executed by the computer system 200. When executed, the instructions cause the computer system 200 to implement the functionality of the present invention as described below.

For the purposes of illustration, the discussion of flowchart 300 shall refer to the structures depicted in FIG. 2.

In preparation for step 310, the detailed specifications of the Disk Drive are understood so as to translate the specifications into a simulation language.

In step 310, a simulation language is used to code instructions for the simulation model of the hard disk drive, according to an embodiment. For example, a simulation language such as Verilog™ can be used for coding instructions for the simulation model of the hard disk drive 220. Similarly, Verilog™ can be used for coding instructions for the simulation model of the host 210. Frequently, simulation languages include many third generation language features, such as If-Then-Else statements that can be used for coding instructions. For example, the specification may contain flowcharts, for example, that describes the logic of the hard disk drive. The If-Then-Else capabilities of the simulation language can be used to code the simulation model of the hard disk drive 220 with the logic described by the flowcharts. Thus, the instructions for the simulation model of the hard disk drive 220 are coded in a manner that complies with a specification that describes the logic of the hard disk drive, which eliminates the need for a schematic of a hard disk drive.

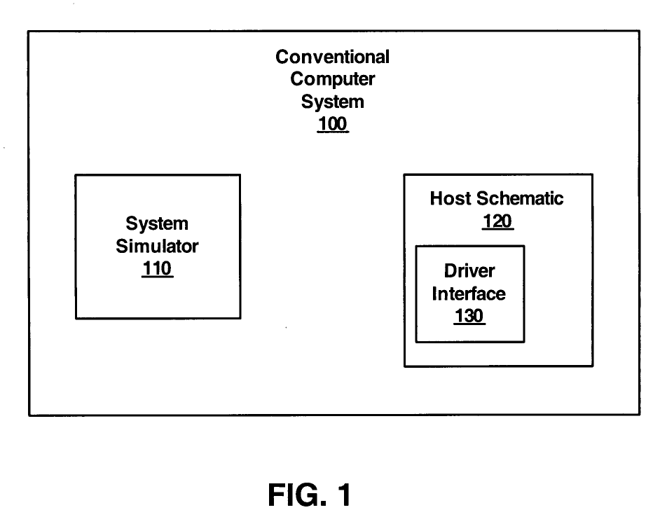

In step 320, the simulation model of a host is enabled to interact with the simulation model of the hard disk drive, according to an embodiment. This entails adding simulation language statements that refer to the simulation model of the disk drive 220 in lieu of simulation language statements describing an open connector, such as that represented by driver interface 130 (FIG. 1). During execution, for example, the computer system 200 is capable of receiving the simulation models 210, 220. More specifically, a user can install the simulation models 210, 220 onto the computer system 200. The instruction receiver 250 is used for receiving the code for the simulation model of the hard disk drive 220, according to one embodiment.

Assuming that the system simulator 280 is Cadence™, the system simulator 280 is used to compile the simulation model of the hard disk drive 220, according to one embodiment. The system simulator 280 can also be used to compile the simulation model of the host 210.

For the sake of illustration, assume that interface 240 represents compact flash I/O. During execution, the simulation model of the host 210 can issue a command to the simulation model of the hard disk drive 220 requesting an identification as to what type of hard disk drive it is. The appropriate command functionality 246 of the simulation model of the hard disk drive 220 can respond, for example, by indicating that it is a compact flash I/O device, for example.

The simulation model of the host 210 now has the information to determine how to issue requests to write data to and/or to read data from the simulation model of the hard disk drive 220. For example, the simulation model of the host 210 can request to write data to memory 270. When the simulation model of the hard disk drive 220 receives the request to write the data, the write data functionality 244 can be used to write the data to the file 272. The simulation model of the host 210 can also request to read data from memory 270. When the simulation model of the hard disk drive 220 receives the request to read data, the read data functionality 242 can be used to read the data from the file 272.

According to one embodiment, from the perspective of the simulation model of the host 210, the reading and writing of data will appear as if it had been performed by a real hard disk drive. According to another embodiment, from the perspective of the simulation model of the host 210, the reading and writing of data will appear to be performed in a manner that it would have been performed by a real hard disk drive as long as the size of the file 272 is not exceeded. More specifically, assuming that the file 272 is capable of storing 2000 sectors of data, the file 272 will provide valid data as long as sector 2000 is not exceeded. Once sector 2000 is exceeded, a predefined set of data will be provided to the simulation model of the host 210.

### Conclusion

Although many of the embodiments described herein referred to hard disk drives, the embodiments of the present invention can be used for any time of disk drive. For example, the embodiments can be used for tape drives. Further, the embodiments can be used for specific types of hard drives such as micro drives.

Although many of the embodiments herein were described using a simulation language to implement the simulation model of the host, alternatively, the simulation model of the host 210 could be implemented as a host schematic 120 instead.

A company can use the published specification for a disk drive to code instructions for the simulation model of the disk drive. The company can use the simulation model for its own purposes or could sell computer readable medium that contains the instructions used for implementing the simulation model. Further, a company could sell an apparatus that implements the instructions for the simulation model of the disk drive in the form of software, hardware, firmware, or a combination thereof.

What is claimed is:

1. An apparatus that enables a simulation model of a host to interact with a simulation model of a disk drive, comprising:
an instruction receiver for receiving instructions for the simulation model of the disk drive, wherein the instructions are coded with a simulation language and the instructions comply with a specification that describes logic of the disk drive; and
the simulation model of the disk drive that enables the simulation model of the host to interact with the simulation model of the disk drive, wherein a schematic of the disk drive is not required for the purpose of enabling the simulation model of the host to interact with the simulation model of the disk drive.

2. The apparatus of claim 1, further comprising:
a system simulator is used to enable the instructions of the simulation model of the disk drive by using a simulation language that the system simulator is capable of simulating to code the instructions for the simulation model of the disk drive.

3. The apparatus of claim 2, wherein the system simulator is Cadence™.

4. The apparatus of claim 1, wherein the simulation model of the disk drive enables the simulation model of the host to interact with the simulation model of the disk drive without requiring a human to analyze outputs generated by the simulation model of the host.

5. The apparatus of claim 1, wherein:
the simulation model of the disk drive is coded with instructions for an interface associated with a type of the disk drive; and
the interface, at least in part, enables the simulation model of the host to interact with the simulation model of the disk drive.

6. The apparatus of claim 1, wherein the interface is selected from a group consisting of compact flash, and parallel ATA.

7. The apparatus of claim 6, wherein the simulation model of the disk drive is coded with instructions for a mode associated with compact flash and wherein the mode selected from the group consisting of memory, input/output device, and integrated device electronics.

8. The apparatus of claim 1, wherein the simulation model of the disk drive is coded with instructions that enable the simulation model of the host to perform an operation selected from a group consisting of writing data to a file and reading data from the file.

9. The apparatus of claim 8, wherein the simulation model of the disk drive:
returns valid data to the simulation model of the host when the size of the file is not exceeded; and
returns a pre-defined set of data to the simulation model of the host when the size of the file is exceeded.

10. The apparatus of claim 8, wherein the file is a preloaded file.

11. The apparatus of claim 1, wherein the simulation model of the disk drive is coded with instruction that enables the simulation model of the host to interact with the simulation model of the disk drive using a command.

12. The apparatus of claim 11, wherein the command is selected from a group consisting of “power on reset,” and “identify”.

13. The apparatus of claim 1, wherein the disk drive is a hard disk drive.

14. The apparatus of claim 1, wherein the disk drive is a microdrive.

15. The apparatus of claim 1, wherein the simulation language is Verilog™.
